(19) United States
(12) Patent Application Publication
(10) Pub. No.: US 2006/0193714 A1
(43) Pub. Date: Aug. 31, 2006

(54) Method, fastening system and auxiliary apparatus for fastening a first component to a second component with a precise separation

(76) Inventor: Wolfgang Werner, Reutlingen (DE)

Correspondence Address: HARNESS, DICKEY & PIERCE, P.L.C., P.O. BOX 828, BLOOMFIELD HILLS, MI, 48303, US

(21) Appl. No.: 11/343,729

(22) Filed: Jan. 31, 2006

(30) Foreign Application Priority Data
Feb. 1, 2005 (DE) 10 2005 005 519.2

(51) Int. Cl. F16B 43/02

(52) U.S. Cl. 411/546

(57) ABSTRACT

The present invention concerns a fastening system for fastening a first component to a second component with a precise separation. The present invention also concerns a method for fastening the first component to the second component with a precise separation, as well as an auxiliary apparatus for attaching the fastening system to the second component in order to place the first component on the fastening system. Preferably, the stud has an external thread and the support washer has a threaded hole matched to the external thread, so the support washer can be screwed onto the stud.

### CROSS-REFERENCE TO RELATED APPLICATIONS

This application claims priority to German Patent Application Serial No. 10 2005 005 519.2, filed on Feb. 1, 2005, which is incorporated by reference herein.

### BACKGROUND OF THE INVENTION

The present invention concerns a fastening system for fastening a first component to a second component with a precise separation. The present invention also concerns a method for fastening the first component to the second component with a precise separation, as well as an auxiliary apparatus for attaching the fastening system to the second component in order to place the first component on the fastening system.

The patent DE 101 38 371 D1 discloses a method and an auxiliary apparatus for fastening a piece of sheet metal to a component with a precise separation. The use of a spacer screw is suggested for this purpose. For example in automaking, a spacer screw serves to fasten a body panel to a component, such as the chassis of the vehicle, with a certain distance between them. The spacer screw proposed in DE 101 38 371 C1 has a radially arranged shoulder that is attached rigidly to the screw in order to place thereon, e.g., an automotive body panel with a precise separation. The spacer screw has, on a side facing the base component, a thread with which the spacer screw can be screwed into the base component. A thread is likewise provided on the side of the spacer screw facing away from the component, in order that a component resting on the shoulder located at the center of the length of the spacer screw can be secured by means of a nut, for example.

Since the position of the shoulder is fixed with respect to the length of the spacer screw, the spacer screw must be screwed into the base component with extreme precision to produce the desired spacing between the base component and the shoulder of the spacer screw. Later adjustment, which is to say after the additional component to be arranged with a separation has been placed on the shoulder, is impossible. Moreover, it is not possible with such a spacer screw to achieve a separation that is greater than the axial distance between the shoulder and the end of the spacer screw facing the base component. The separation can merely be reduced by screwing in the spacer screw. In addition, the danger exists that the established separation of a spacer screw that has already been screwed into the base component may change after the fact. A change of this nature may be brought about by such means as vibrations, such as occur during vehicle travel.

In addition, welding studs are known for fastening two components together, especially in automotive construction. In this context, a stud-shaped or pin-shaped element is welded to the base component. These studs may be provided with an external thread. In general, studs are produced by cold extrusion. A flange with a diameter greater than that of the stud is produced in the process. This flange increases a weld area. In addition, this flange achieves the result that an arc (in arc welding) does not extend to the cylindrical part of the stud, thus permitting uniform welding.

### SUMMARY OF THE INVENTION

It is thus an object of the present invention to provide a method, a fastening system, and an auxiliary apparatus for attaching the fastening system that improve the fastening of a first component to a second component with a precise separation. This object is attained by a fastening system that has a stud and a support washer. The first component is placed on a surface of the support washer that faces the first component. In this context, the support washer can be coupled to the stud such that any desired separation between the surface of the support washer facing the first component and an end of the stud facing the second component can be adjusted in the axial direction of the stud. This object is further attained by a method having the steps: delivery by a feeder of a fastening system of the above-mentioned type; setting of any desired separation through axial adjustment of the support washer relative to the stud by means of an adjusting device; joining of the adjusted fastening system to the second component by means of a joining device; and placement and fastening of the first component on the support washer. In addition, the object is attained by an auxiliary apparatus for attaching a fastening system of the above-mentioned type, wherein the auxiliary apparatus has a feeder, an adjusting device, a joining device, and a control unit.

Preferably, the stud has an external thread and the support washer has a threaded hole matched to the external thread, so the support washer can be screwed onto the stud. Since the support washer is not rigidly attached to the stud, but instead is movably attached thereto, nearly any desired separation can be set, where the maximum can be nearly the entire length of the stud. Preferably the support washer is preadjusted to the middle of the stud height, so separations that are both greater and smaller than the middle separation can be set. It is also advantageous that a desired separation can be set even before the installation of the fastening system.

According to a preferred embodiment, one of the threads has a polygonal shape or a pitch error. A stiffness between the stud and the support washer is achieved by this means. This stiffness prevents a separation that was set before installation of the fastening system from changing (after the fact). It has proven to be advantageous for the external thread of the stud to extend essentially over the entire length of the stud. When this is the case, the stud is easy to manufacture. It is only necessary to cut a single thread, thus saving both time and costs in manufacturing the fastening system according to the invention.

It is also advantageous if the stud has, at its end facing the second component, a flange for joining the stud to the component. The flange enlarges the area available for joining the stud to the second component, and also ensures exact orientation of the stud relative to the base component, where the orientation is generally selected such that the stud stands perpendicular to the surface of the base component. There is no need to provide a rivet nut in the base component.

According to another preferred embodiment, the support washer has at least one tool receptacle in one of its surfaces, particularly in the surface facing the first component. By means of the tool receptacle, a factory preset separation can be adjusted by an external tool having appropriate means that can engage in the tool receptacles provided on the support washer. It is further of advantage if the threaded hole has a collar, which can project out of the surface of the support washer facing the first component, and which is provided with means that make it possible to adjust the support washer in the axial direction of the stud after the fact once the first component has been arranged on the support washer. The separation can thus also be corrected after the fact if the process in which the fastening system is joined to the base component should misadjust the preset separation. Preferably the means for adjustment after the fact are adapted to work with an external tool. In this way, the after-the-fact adjustment can be automated. According to an advantageous embodiment, the means for after-the-fact adjustment are embodied as a wrench flat, a polyhedral shape, or a tool receptacle. These means represent common variations with which tools can adjust or turn the support washer.

According to another embodiment, the stud is a welding stud, the flange is a welding flange, and the stud is joined to the second component by welding. The stud welding technique makes possible an integral joint between the stud and the base component. The fastening system according to the invention can be attached to the base component in a simple manner. It is also advantageous if the stud has, at its end facing the first component, a pilot tip. This measure ensures that it is easy to place the first component on the stud, or vice versa, in order to quickly and precisely unite the two components to be united with one another. It is further preferred for the stud to be a metric stud. Additionally, the fastening system according to the invention can have a nut, by means of which the first component can be affixed to the support washer.

It has proven advantageous in the method according to the invention if the arbitrary separation to be set is determined by means of a sensor unit that determines the separation between the first component and the second component. In this way, any desired separations can be set in accordance with the situation. This means that the separations to be set are not stored in advance in a memory unit, for example, but instead are determined based on the specific case by means of a sensor unit. In doing so, the sensor unit delivers appropriate information to a control unit, which in turn acts on an adjusting device, which sets the desired separation. Otherwise, which is to say if the separation is not to be measured for each situation, a memory device can be provided which, as a function of a location where the fastening system is to be placed, outputs a separation that is associated with this location and specifies a predetermined separation. Of course, the features mentioned above and those to be explained below need not be used only in the specific combinations given, but may also be used in other combinations or alone without departing from the scope of the present invention. Example embodiments of the invention are shown in the drawings and are explained in detail in the description below.

### BRIEF DESCRIPTION OF THE DRAWINGS

FIG. 1 shows a side view of a fastening system according to the present invention.

FIG. 2 shows a top view of the fastening system from FIG. 1.

FIG. 3 schematically shows an installation with which a fastening system according to the invention can be attached to a base component.

FIG. 4 schematically shows another element of the installation from FIG. 3.

FIG. 5 shows a flowchart of the method according to the present invention.

### DETAILED DESCRIPTION

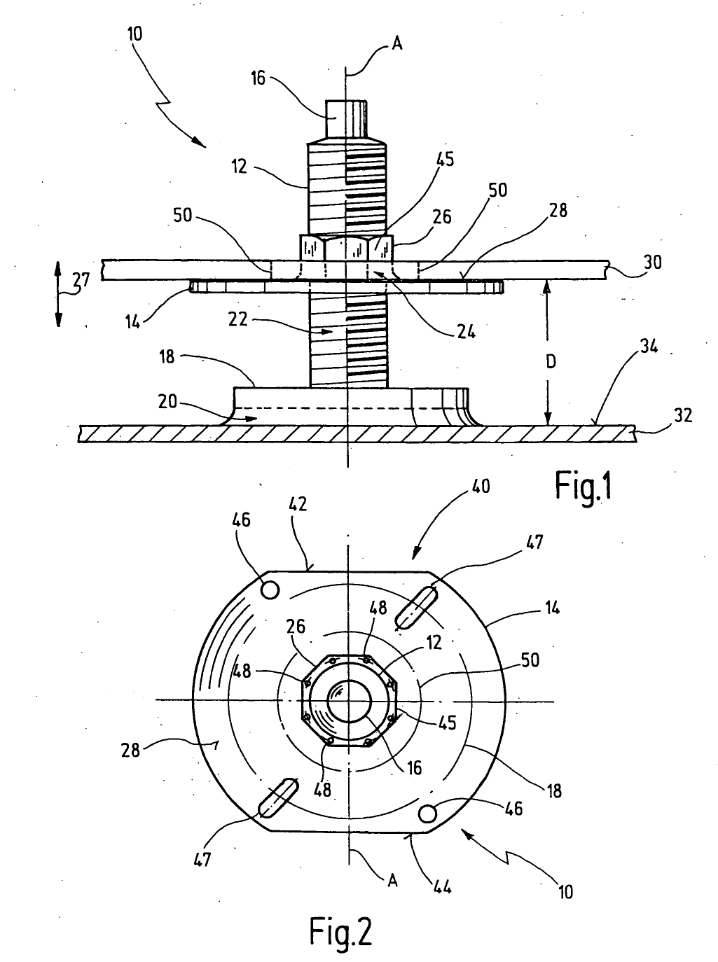

In the discussion below, a fastening system according to the present invention is generally designated 10. FIG. 1 shows the fastening system 10 in a first embodiment of the present invention. The fastening system 10 includes a preferably cylindrical stud 12. The center axis of the stud 12 is labeled A. The fastening system 10 further includes a support washer 14. The stud may optionally have at one of its axial ends a so-called pilot tip 16. During installation of a component on a base component, the pilot tip 16 makes it easier to find an opening provided in said component. Also, the stud 12 in FIG. 1 transitions at its end facing the base component into a flange 18.

The stud 12 shown in FIG. 1 is a welding stud, which is to be welded to a base component. For this reason, the bottom part of the flange 18, which is separated from the upper part of the flange 18 in the drawing by a dashed line, constitutes what is known as a burnoff zone 20. When the stud 12 is welded to the base component, the burnoff zone 20 forms an integral joint between the stud 12 and the base component. In welding, especially in drawn arc welding, a voltage is applied between the stud 12 and the base component that, at a certain distance between the base component and the stud 12, which is moved toward the base component, is sufficient to “ignite” an arc between the two. The energy released in this process is sufficient to melt both the flange 18 and the surface of the base component. Subsequently, the stud is lowered onto the melted surface, and an integral joint is produced.

In addition, the stud 12 in FIG. 1 has an external thread 22. This external thread 22 can work together with a threaded hole 24 of the support washer 14 in such a manner that the support washer 14 can be adjusted in the axial direction A relative to the stud by rotation. The thread of the threaded hole 24 is appropriately matched to the external thread 22 of the stud 12. In the special embodiment of the threaded hole 24 shown in FIG. 1, the threaded hole has a collar 26 that projects out of a surface 28 of the washer 14, with the surface 28 facing a first component 30. The first component 30 can be arranged at a precise separation from a second component 32, namely the base component 32, by means of the inventive fastening system 10.

The separation between the surface 28 of the support washer 14 facing the first component 30 and a surface 34 of the base component 32 is labeled D in FIG. 1. This distance or separation D can be varied by means of the inventive fastening system. To this end, the support washer 14 is turned in a desired direction along the longitudinal axis A of the stud. This motion of the washer 14 relative to the stud 12 is indicated in FIG. 1 with an arrow 27.

FIG. 2 shows a top view of the fastening system 10 from FIG. 1, wherein the first component 30 and the base component 32 are not depicted in FIG. 2. Starting from the center point of FIG. 2, the individual elements that are already shown in FIG. 1 are described again below. In the top view of FIG. 2, the pilot tip 16 is located closest to the center point. Adjacent to this is the stud 12. The collar 26 of the threaded hole 24 (see FIG. 1) has a larger diameter here than the stud 12. In FIG. 2, a circle 50 drawn with a dashed and dotted line schematically indicates an opening 50 of the first component 30. The base surface of the flange 18 is indicated with a dashed line, since it is hidden in the top view in FIG. 2 of the fastening system 10 from FIG. 1 by the surface 28 of the support washer 14. The size or diameter of the contact surface 28 of the washer 14 may be chosen as desired, and can be varied as a function of characteristics of the component 30 to be fastened. In the example in FIG. 2, the contact surface 28 of the support washer 14 is shown in the form of a wrench flat 40 with straight-line sides 42 and 44. This wrench flat 40 is merely an example, however. The support washer 14 could also take another form, for example a polyhedral shape.

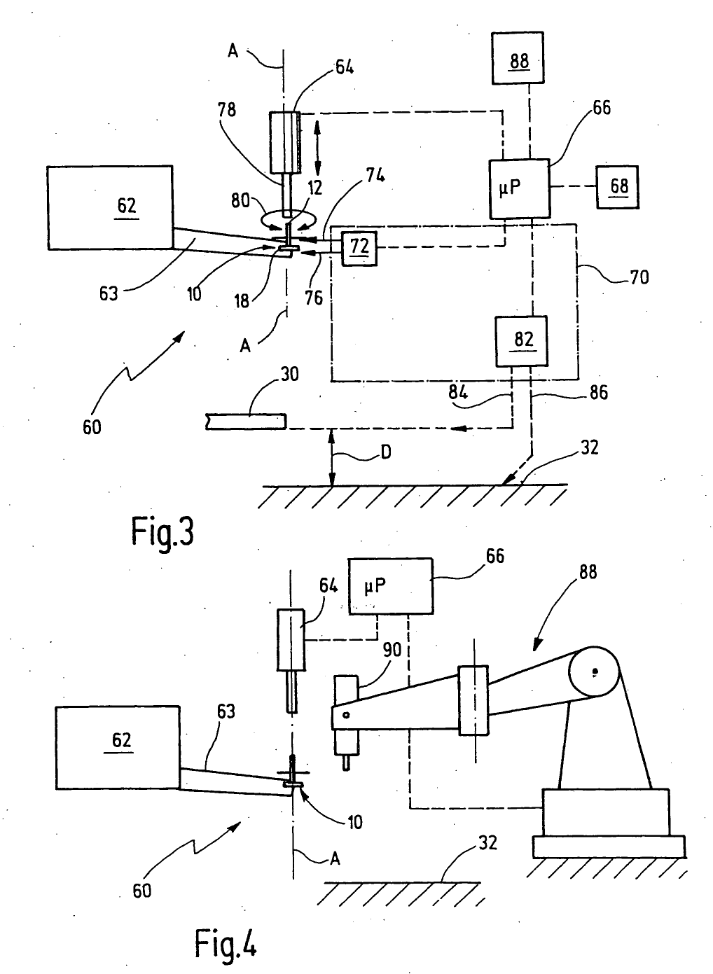

In addition, the support washer 14 can have tool receptacles, for example in the form of holes 46 or slots 47, so that an external tool can engage in these receptacles 46 or 47 in order to axially adjust the support washer 14 by rotation. The slots 47 have the advantage that satisfactory engagement of the external tool is still possible in extreme tolerance conditions between the fastening system 10 and an adjusting device that will be explained in greater detail in connection with FIGS. 3 and 4. It is a matter of course that the various tool receptacles 46 and 47 shown in FIG. 2 could all be designed in the form of holes 46 or slots 47. The number of tool receptacles can also be varied, as can their arrangement relative to the washer 14.

The collar 26 of the threaded hole 24 can also have tool receptacles 48 in order to adjust the support washer 14 in the axial direction. The tool receptacles 48 can also be used to adjust the support washer 14 when the first component 30 (see also FIG. 1) has already been placed on the support washer 14. In order to be able to place the first component 30 on the support washer 14 at all, the first component 30 should have the opening 50. As a rule, the opening 50 has a larger diameter than the collar 26. The collar 26 is thus exposed and can be accessed by an external tool after the first component 30 has been placed on the support washer 14 in order to adjust the support washer 14 after the fact.

To this end, it is not strictly necessary that the height of the collar 26 project past the first component 30 in the way shown in FIG. 1. The collar 26 in FIG. 1 is depicted as being higher than the thickness of the first component 30 merely for illustrative purposes. The component 30 can be locked in position on the support washer 14 with an additional nut, not shown in FIG. 1, that is screwed onto the stud 12 over the pilot tip 16. In this context, it can be advantageous if a plain washer is provided between the nut (not shown in FIG. 1) and the component 30. For this reason, the collar 26 is shown in FIG. 1 as projecting past the first component 30. The collar 26 has a polyhedral shape 45 in FIG. 1. In like manner to the support washer 14, however, it could take the form of a perforated surface so that an external tool can adjust the axial position of the support washer, even after the fact. Conversely, the support washer 14 can of course also have a polyhedral shape instead of being designed in the form of a perforated surface.

The external thread 22 and/or the internal thread of the threaded hole 24 can have a polygonal shape or a pitch error in order to ensure stiffness between the washer and the stud. The surface of the stud may be provided with a corrosion protection that is weldable. The washer preferably has a diameter of 23 to 26 millimeters, wherein the diameter should be matched to the component, such as a fender, for example. The surface of the washer 14 can be coated without regard to welding. Since the washer 14 is covered by the first component 30 and the frictional forces of a nut (not shown) act on the first component 30, the washer 14 is not loaded in rotation when the nut is tightened. Consequently, the stiffness of the thread should be adequate, wherein it should at least ensure that, for example, it prevents misadjustment of the washer 14 during singling in a feeder or during transport of the system 10.

FIGS. 3 and 4 show an apparatus 60 with which the fastening system 10 of the present invention can be attached to a second component 32 in order to subsequently connect it to a first component 30, wherein the first component 30 and the second component 32 should have a separation D from one another in the installed state. This apparatus 60 includes a feeder 62 with a feed rail 63 through which the fastening systems 10 can be fed in a singled manner, which is to say individually, from a reservoir (not shown) of the feeder 62. In addition, the apparatus 60 has an adjusting device 64, a control unit 66, and optionally a memory unit 68. Optionally, a sensor unit 70 can also be provided which can include a first sensor 72 and a second sensor 82.

Since the fastening system 10 is preferably fed automatically to the adjusting device 64, it can be useful for the support washer 14 to have a predefined axial position relative to the stud 12, i.e., a preset separation. To this end, after the individual elements of the fastening system have been manufactured and optionally coated with anti-corrosion coating, the fastening system can be further processed with an automatic bolt tightener (not shown in FIGS. 3 and 4). The support washer 14 is initially screwed against the flange 18 (see FIG. 1) with a predetermined torque by the automatic bolt tightener. Torques of 4-6 Nm are preferred in this context. This process step can ensure that the support washer 14 is delivered to the feeder 62 without danger of loss, and in particular, without danger of misadjustment, with a predetermined separation relative to the stud 12. This also results in a position of the center of gravity which can be defined such that the fastening system 10 or the stud 12 is singled with a predetermined orientation in the feeder 62.

Oftentimes, the reservoir of the feeder 62 is filled with the fastening system 10 as a bulk commodity. This is why a singling process may be necessary, which process is facilitated by the position of the center of gravity. In this way, the fastening system 10 can easily be fed via the feed rail 63 to the adjusting device 64, which then sets a relative separation to be determined, for example with the sensor unit 70. This has the advantage that the inventive fastening system can be used for different vehicle types.

A preset separation of the washer 14 relative to the stud 12 of the fastening system 10 can thus be set by the adjusting device 64. For this purpose, the adjusting device 64 has, for example, a hollow tool 78 which can be guided over the projecting collar 26, for example (see FIG. 1), in order to adjust the washer 14.

The position of the washer 14 relative to the stud 12 can be measured with a first sensor 72 of the sensor unit 70. This is schematically indicated in FIG. 3 by an arrow 74. The position of one end of the stud 12, for example the flange 18, which faces the second component 32 in the installed state can likewise be measured by the first sensor 72, which is schematically indicated in FIG. 3 by an arrow 76. The first sensor 72 delivers these measurement results to the control unit 66, which can be embodied by a microprocessor, for example. However, the control unit 66 can also be implemented with any other desired control system that can control the apparatus 60, such as a PC or a mainframe computer, for example.

The control unit 66 checks whether the preset separation agrees with a separation to be set, in order to change the relative position of the washer 14 if necessary by means of the adjusting device 64 and its tool 78, in that the washer 14 is rotated by the tool 78, as is schematically indicated by an arrow 80 in FIG. 3. On the one hand, the separation D to be set can be retrieved from a data record stored in the memory unit 68, wherein the data record contains at least a link between the location where the fastening system 10 is to be located and a corresponding separation D.

Alternatively, however, the separation D to be set can be determined with the aid of the second sensor 82. The second sensor 82 is capable of determining the position of an arbitrary first component 30 relative to the base component 32. This is schematically indicated in FIG. 3 by the arrows 84 and 86. Thus, with the second sensor 82, it is possible to work in a situation-dependent manner. For example, the first component 30 shown in FIG. 3 could already be attached relative to the base component 32 by means of another fastening system 10, and it is now desirable to install another first component 30 at the same separation D as the already installed component 30. The second sensor 82 is helpful in this case.

FIG. 4 shows another element of the apparatus 60, namely a welding robot 88. To make for a simpler representation, some of the elements shown in FIG. 3 are not shown in FIG. 4 and vice versa. The welding robot 88 is also coupled to the control unit 66. The welding robot 88 joins the system 10 to the base component 32. It can be seen in FIG. 4 that the adjusting device 64 has moved away from the fastening system 10 along the axis A. This occurs when the separation D to be set has been set by the adjusting device 64. Then, the welding robot “grips” the fastening system. To this end, the welding robot 88 can be equipped with grippers (not shown), for example, which pick up the fastening system 10 and also provide for transmission of a welding current in that a voltage is applied through the grippers.

Once the robot 88 has moved its welding tool 90 to an e.g., preprogrammed position, the actual welding process can take place. Burnoff at the stud flange 18 that occurs in this process is either known or can be determined (after the fact) by means of the sensor unit 70. Preferably, the burnoff is stored in the memory unit 68 of the control unit 66 so that the adjustment path determined by the second sensor 82, in other words the distance D, can account for the burnoff. Moreover, process data acquisition from the welding process makes trend observation possible, which prevents variations in the welding process from resulting in deviations in the position tolerances.

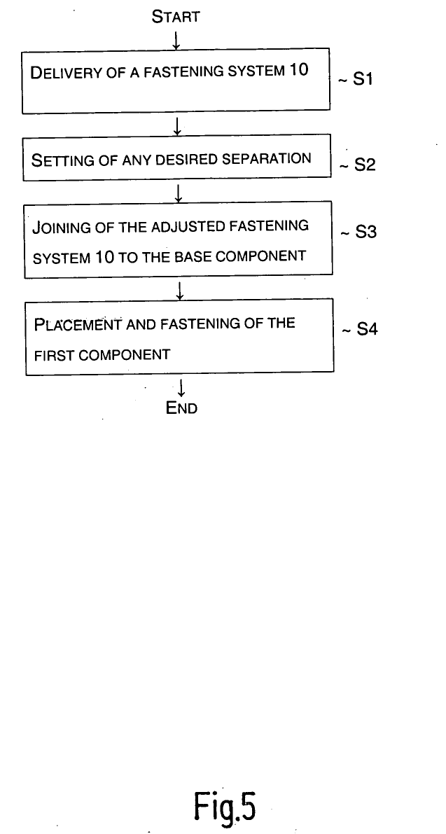

The method according to the present invention is described here with reference to FIG. 5, where the reader should take into account the statements made in connection with FIGS. 3 and 4. According to the method for fastening a first component 30 to a second component 32 with a precise separation, a fastening system 10 is delivered by a feeder in a step S1. Next, in a step S2, any desired separation is set by axial adjustment of the support washer relative to the stud by means of an adjusting device. In a step S3, the adjusted fastening system is joined to the second component by means of a joining device, and in a step S4 the first component is placed on and fastened to the support washer.

It is a matter of course that the inventive fastening system 10 can be joined to the base component by means other than welding. The term “joining” includes any process by which the fastening system is attached to the base component in a lasting manner. A different type of adjustable attachment between stud and washer is also possible. Thus, the attachment can take place not only by means of threads, but also, for example, by means of a system that has a catch that snaps into teeth, such as is known from cable ties. Any other type of attachment between the washer and stud is possible as long as adjustability of the position of the washer relative to the stud is guaranteed. Furthermore, it is not strictly necessary for the stud to have a flange 18 (see FIG. 1). The stud 12 could also screwed into a corresponding rivet nut (not shown) worked into the second component 32. Nor is the provision of a collar strictly necessary. The threaded hole 24 could also extend only through the washer 14, or in other words could have no collar 26.

1. A fastening system comprising a first component and a second component fastened to the first component with a precise separation therebetween, a stud and a support washer, the first component being placed on a support washer surface that faces the first component, wherein the support washer can be coupled to the stud such that any desired separation between the surface of the support washer facing the first component and an end of the stud facing the second component can be adjusted in the axial direction of the stud.

2. The fastening system according to claim 1, wherein the stud has an external thread and the support washer has a matching threaded hole, so the support washer can be screwed onto the stud.

3. The fastening system according to claim 2, wherein one of the threads has a polygonal shape or a pitch error so that a stiffness is present between the stud and the support washer.

4. The fastening system according to claim 2, wherein the external thread of the stud extends essentially over the entire length of the stud.

5. The fastening system according to claim 1, wherein the stud has, at its end facing the second component, a flange for joining the stud to the second component.

6. The fastening system according to claim 1, wherein the support washer includes at least one tool-receiving flat for adjustment of the support washer in the axial direction of the stud relative to the stud.

7. The fastening system according to claim 1, wherein the support washer has at least one tool receptacle in at least one of its surfaces.

8. The fastening system according to claim 1, wherein a threaded hole of the support washer is part of a collar which projects out of the surface of the support washer facing the first component, and which is provided with means for adjusting the support washer in the axial direction of the stud after the fact once the first component has been placed on the support washer.

9. The fastening system according to claim 8, wherein the means for after-the-fact adjustment are adapted to work with an external tool.

10. The fastening system according to claim 8, wherein the means for after-the-fact adjustment are embodied as at least one of: (a) a wrench flat, (b) a polyhedral shape, and (c) a closed periphery, tool receptacle.

11. The fastening system according to claim 5, wherein the stud is a welding stud, the flange is a welding flange, and the stud is joined to the second component by welding.

12. The fastening system according to claim 1, wherein the stud has, at its end facing the first component, a pilot tip.

13. The fastening system according to claim 1, wherein a distance between the support washer and a reference point is automatically sensed and the location of the support washer is automatically set relative to the stud based at least in part on the distance sensed.

14. The fastening system according to claim 1, further comprising a nut affixing the first component to the support washer.

15. A fastening system comprising:
a weld stud having an axially elongated shank with an external pattern thereon, a laterally enlarged flange stationarily secured to the shank adjacent an end of the stud, a substantially flat plane of the flange extending substantially perpendicular to an elongated axis of the shank, a welding burnoff zone located adjacent the flange; and
a support washer having a support surface laterally enlarged along a support plane substantially parallel to the plane of the flange, the support washer having an internal hole operably engaging the pattern of the stud, and a tool-receiver being integrally part of the support washer to allow adjustable axial movement of the support washer relative to the stud.

16. The fastening system according to claim 15, wherein the support washer further comprises a collar axially extending from the washer support surface as a single piece.

17. The fastening system according to claim 16, further comprising a polyhedral shape defining the external surface of the collar.

18. The fastening system according to claim 16, further comprising a thread internally disposed within at least one of the collar and the hole of the support washer.

19. The fastening system according to claim 15, wherein the tool-receiver includes an elongated, internal slot disposed in the support surface.

20. The fastening system according to claim 15, wherein the tool-receiver includes multiple closed-circular apertures disposed in the support surface.

21. The fastening system according to claim 15, wherein a peripheral edge of the support washer includes at least one flat segment and at least one arcuate segment.

22. The fastening system according to claim 15, wherein the pattern of the stud is a continuous thread and the support washer is rotatably adjustable along the shank of the stud.

23. A fastening system comprising:
a weld stud;
a support member selectively engagable to the weld stud in a removable manner;
an arc welding head operably transmitting a welding current through the stud;
a sensor operably sensing a value associated with a position of the member relative to the stud when the member is attached to the stud;
a controller operably receiving a signal from the sensor indicative of the sensed value; and
a positioner tool operably engaging the member and adjusting the positioning of the member relative to the stud based on the controller determination, in an automated manner.

24. The fastening system according to claim 23, wherein the member is a support washer.

25. The fastening system according to claim 23, wherein the sensor senses the value prior to arc welding of the stud.

26. The fastening system according to claim 23, wherein the sensor senses the value after arc welding of the stud.

27. The fastening system according to claim 23, further comprising a second sensor connected to the controller, the second sensor sensing another value associated with the relative positioning of the member relative to the stud.

28. A fastening system comprising:
a weld stud;
an automotive vehicle panel upon which the stud is welded;
a support member selectively engagable to the weld stud in a removable manner;
a component removably attached to the stud and contacting against the support member, positioning of the support member setting the spacing distance between the component and the panel;
a welding head operably welding the stud;
a sensor operably sensing a value indicative of a distance;
a controller operably receiving a signal from the sensor; and
positioning of the member relative to the stud being automatically adjusted based, at least in part, on the controller determination.

29. The fastening system according to claim 28, wherein the member is an internally threaded support washer.

30. The fastening system according to claim 28, wherein the sensor senses the value prior to arc welding of the stud.

31. The fastening system according to claim 28, wherein the sensor senses the value after arc welding of the stud.

32. The fastening system according to claim 28, further comprising a second sensor connected to the controller, the second sensor sensing another value associated with the relative positioning of the member relative to the stud.

33. A method of manufacturing by precisely setting the separation between a first component and a second component of an automotive vehicle, the method comprising:
(a) engaging an internally threaded support washer with an externally threaded weld stud;
(b) welding the stud to the second component;
(c) supporting the first component upon the washer a distance spaced away from the second component; and
(d) accessing the washer after step (c) to adjust the distance by moving the washer relative to the stud.

34. The method of claim 33, further comprising automatically adjusting the distance and the positioning of the washer relative to the stud, and coupling the first component to the stud with a nut.

35. The method of claim 33, further comprising automatically sensing the distance between the first component and the second component.
